(19) United States
(12) Patent Application Publication
(10) Pub. No.: US 2016/0221312 A1
(43) Pub. Date: Aug. 4, 2016

(54) Enhanced Stretched Cling Performance Polyolefin Films

(71) Applicant: EXXONMOBIL CHEMICAL PATENTS INC., Baytown, TX (US)

(72) Inventor: Paul M. German, Cypress, TX (US)

(21) Appl. No.: 15/021,832

(22) PCT Filed: Sep. 5, 2014
(86) PCT No.: PCT/US2014/054287

§ 371 Date: Mar. 14, 2016

Related U.S. Application Data
(60) Provisional application No. 61/891,589, filed on Oct. 16, 2013.

(51) Int. Cl. B32B 27/32

(52) U.S. Cl. CPC B32B 27/32; B32B 2307/72; B32B 2307/748; B32B 2307/54; B32B 2553/00

(57) ABSTRACT

A stretch cling film having Cling Retention greater than 50% comprising a cling layer comprising an ethylene-based polymer wherein the film Parallel Cling Force at 200% is greater than 50 g. More particularly is disclosed a multilayered stretch cling film having Cling Retention greater than 50%, wherein the film comprises a cling layer comprising an ethylene-based polymer having (a) a melt index I₂ within the range 5.0 to 25.0 g/10 min, (b) a melt index ratio, I₂₁/I₂ within the range of 9.0 to 40.0, and (c) a density within the range from 0.910 to 0.930 g/cm³. The cling layer may also include a propylene-based elastomer, polyalphaolefin, or a combination thereof.

### CROSS REFERENCE TO RELATED APPLICATIONS

This application claims the benefit of U.S. Provisional Application No. 61/891,589, filed Oct. 16, 2013, the disclosure of which is hereby incorporated by reference in its entirety.

### FIELD OF THE INVENTION

The present invention relates to stretchable cling films, and in particular to polyethylene-based films having improved cling performance.

### BACKGROUND

Stretch-cling films have wide application, including bundling packaged food and other goods. One application of particular interest is in the bundling of goods for shipping and storage, for example, the bundling of large rolls of carpet, fabric, or the like. A film having cling properties to prevent unraveling of the film from the pallet is therefore desirable. To impart cling properties or improve the cling properties of a particular film, a number of techniques have been employed, such as the addition of tackifying additives or use of polar ethylene copolymers such ethylene acrylates in the (co)polymer. Common tackifying additives include polybutenes, terpene resins, alkali metal and glycerol stearates, and oleates and hydrogenated rosins, and rosin esters.

Certain soft polyolefins—either low molecular weight waxes or liquids, or low-crystallinity copolymers—have been used to enhance cling properties of polyolefins. While at relatively low levels, the soft polyolefin tends to disperse in the polyolefin matrix, at higher levels the soft polymer tends to aggregate, forming domains within the polyolefin matrix, thereby placing an upper limit on the amount of soft polymer that can be incorporated for cling improvement. Further, soft polyolefins can cause blocking. In other words, after a certain concentration, the addition of more of the soft polyolefin does not improve the cling performance and may contribute to other undesirable film properties such as blocking. In addition, cling performance can suffer in particular in dusty or low temperature environments. A composition suitable for cling films that can increase the cling performance of the film particularly in challenging environments would be useful. What would be particularly desirable is to not only improve the cling properties of a film, but to have the film improve further upon stretching the film as part of its function.

Relevant documents include U.S. Ser. No. 61/857,352 filed Jul. 23, 2013; U.S. Ser. No. 61/823,039 filed May 14, 2013; US 2002-050124, US 2006-223942, US 2008-0311368, US 2010-129632, U.S. Pat. No. 5,114,763, U.S. Pat. No. 5,538,790, U.S. Pat. No. 7,655,317, and U.S. Pat. No. 7,951,873.

### SUMMARY

A stretch cling film having Cling Retention greater than 50% comprising a cling layer comprising an ethylene-based polymer wherein the film Parallel Cling Force at 200% is greater than 50 g. More particularly is disclosed a multilayered stretch cling film having Cling Retention greater than 50%, wherein the film comprises a cling layer comprising an ethylene-based polymer having (a) a melt index 1₂ within the range 5.0 to 25.0 g/10 min, (b) a melt index ratio, I₂₁/I₂ within the range of 9.0 to 40.0, and (c) a density within the range from 0.910 to 0.930 g/cm³.

### BRIEF DESCRIPTION OF THE DRAWINGS

FIG. 1 is a representative bar graph of data demonstrating the improved performance of the inventive cling films; and

FIG. 2 is a representative line graph of data demonstrating the enhanced Cling Retention of the inventive films as a function of the level of stretch imparted thereon.

### DETAILED DESCRIPTION

The films of the present invention have an outer cling-layer of a multi-layered film that has improved cling properties and is particularly adapted for having increased “Cling Retention” as the film is stretched. The films are particularly well suited for polyethylene stretch films of the type that are formed predominantly from linear low density polyethylene (LLDPE). Preferably, the film or cling-layer comprises a predominant amount of a relatively high melt index (MI, “I₂”, 190/2.16) LLDPE (“ethylene-based polymer”) and lesser amounts of one or more polyolefin additives.

Cling after film stretching is required to secure stretch film wrapping around products being wrapped. Stretch film cling declines significantly upon stretching and can be reduced to 33% or less of the un-Stretched Cling value at typical stretch levels. The current invention provides greatly improved Cling Retention (200% Stretched Cling/un-Stretched Cling as a percentage). Cling retention values of 50% to 70% were demonstrated in test films, which allow lower un-Stretched Cling, in addition to improved 200% Stretched cling. Lower un-stretched cling provides easier film roll unwind. Further benefits in the ability to produce higher cling stretched films, while maintaining un-Stretched Cling and associated roll blocking at acceptable levels, by increasing cling additive resin levels (“polyolefin additives” such as Vistamaxx™ or Exact™) to the base high melt index ethylene-based polymer are also achieved.

The inventive films are referred to as comprising the ethylene-based polymers, and, alternatively, the inventive films are referred to as comprising a “cling layer” which is a layer of material co-continuous with one or more other sub-layers of polymer material, and at least that “cling layer” comprises the ethylene-based polymers. When film thicknesses are referenced, this refers to the thickness of the overall “film” or only the cling layer of a “multi-layered” film. For instance, a typical total film thickness may be 12 microns, of that total film the cling layer may be 10% of that, or 1.2 microns.

### Ethylene-Based Polymers

The so called “ethylene-based polymers” described herein are the primary component of the inventive films or cling layer. The ethylene-based polymers herein refer to a polyethylene copolymer having at least 51.0 wt % ethylene-derived units, or within a range of from 99.5 to 51.0 wt %, 99.0 to 65.0 wt %, 99.0 to 75.0 wt %, 99.0 to 85.0 wt %, or 99.0 to 95.0 wt %, of polymer units derived from ethylene and 0.5 to 49.0 wt %, 1.0 to 35.0 wt %, 1.0 to 25.0 wt %, 1.0 to 15.0 wt %, 1.0 to 5.0 wt %, or 1.0 to 3.0 wt % of polymer units derived from one or more C₃ to C₂₀ α-olefin comonomers (weight percentages are by weight of the whole polymer), preferably C₃ to C₁₀ α-olefins, and more preferably C₄ to C₈ α-olefins. The α-olefin comonomer may be linear or branched, and two or more comonomers may be used, if desired. Examples of suitable comonomers include propylene; 1-butene; 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Particularly suitable comonomers include 1-butene, 1-hexene, and 1-octene, 1-hexene being most preferred.

The ethylene-based polymers preferably have a melt index, I₂, of at least 5.0 or 6.0 g/10 min, or within the range from 5.0 to 12.0 or 16 or 20 or 25 g/10 min, particularly 5.0 to 11.0 g/10 min, or 6.0 to 10.0 g/10 min, more particularly 7.0 to 9.0 g/10 min, as determined in accordance with ASTM D-1238 under a load of 2.16 kg and at a temperature of 190° C. Some ethylene-based polymers also have a high-load melt index, I₂₁, of 80.0 to 160.0 g/10 min, particularly 110.0 to 160.0 g/10 min, more particularly 120.0 to 140.0 g/10 min, 125.0 to 135.0 g/10 min, or 127.5 to 132.5 g/10 min, as determined in accordance with ASTM D-1238 under a load of 21.6 kg and at a temperature of 190° C. The melt index ratio (I₂₁/I₂) of the ethylene-based polymers has a lower limit of 9.0 and an upper limit of 40.0. In particular embodiments, the lower limit on the melt index ratio may be 9.0, 10.0, 12.0, 14.0, 15.0, 16.0, 17.0, 18.0, 20.0, 22.0, 25.0, 27.5, 30.0, 35.0, 37.5, or 40.0. The upper limit on the melt index ratio may be 16.0, 17.0, 18.0, 20.0, 22.0, 25.0, 27.5, 30.0, 35.0, 37.5, or 40.0. Any combination lower and upper limits should be considered to be disclosed by the above limits on the melt index ratio, e.g., 9.0 to 40.0, 12.0 to 20.0, 16.0 to 18.0, 10.0 to 22.0, etc.

Particular ethylene-based polymers have a density of from 0.910 to 0.930 g/cm³; more particularly 0.912 to 0.928 g/cm³, 0.914 to 0.926 g/cm³, 0.915 to 0.920 g/cm³, or 0.917 to 0.919 g/cm³, determined using chips cut from plaques compression molded in accordance with ASTM D-1928 Procedure C, aged in accordance with ASTM D-618 Procedure A, and measured as specified by ASTM D-1505.

Typically, although not necessarily, ethylene-based polymers have a molecular weight distribution (MWD, defined as M_{w}/Mₙ) of 2.0 to 5.5, preferably 3.0 to 5.0, or 3.5 to 5.0, and most preferably within a range from 2.5 to 3.0. The expression “M_{w}/Mₙ” is the ratio of the weight average molecular weight (M_{w}) to the number average molecular weight (Mₙ). The weight average molecular weight, number average molecular weight, and z-average molecular weight (respectively) is given by:

$${M}_{w} = \frac{{\sum }_{i} {n}_{i} {M}_{i}^{2}}{{\sum }_{i} {n}_{i} {M}_{i}} {M}_{n} = \frac{{\sum }_{i} {n}_{i} {M}_{i}}{{\sum }_{i} {n}_{i}} {M}_{z} = \frac{{\sum }_{i} {n}_{i} {M}_{i}^{3}}{{\sum }_{i} {n}_{i} {M}_{i}^{2}} ;$$

where nᵢ in the foregoing equations is the number fraction of molecules of molecular weight Mᵢ. Measurements of M_{w}, M_{z}, and Mₙ are typically determined by Gel Permeation Chromatography as disclosed in 34(19) MACROMOLECULES 6812 (2001).

The ethylene-based polymers herein generally have little to no long-chain branching. Particular ethylene-based polymers have from 0.0 to 2.0 long-chain branches/1000 total carbons, from 0.0 to 1.5 long-chain branches/1000 total carbons, from 0.0 to 1.0 long-chain branches/1000 total carbons, from 0.0 to 0.5 long-chain branches/1000 total carbons, from 0.0 to 0.3 long-chain branches/1000 total carbons, from 0.0 to 0.2 long-chain branches/1000 total carbons, from 0.0 to 0.1 long-chain branches/1000 total carbons, from 0.0 to 0.05 long-chain branches/1000 total carbons, from 0.0 to 0.02 long-chain branches/1000 total carbons, or 0.0 to 0.01 long-chain branches/1000 total carbons. Ethylene-based polymers having no measurable long-chain branching are preferred.

Various methods are known for determining the presence of long-chain branches. For example, long-chain branching can be determined using ¹³C nuclear magnetic resonance (NMR) spectroscopy and to a limited extent, e.g., for ethylene homopolymers and for certain copolymers, and it can be quantified using the method of Randall (C29(2&3) JOURNAL OF MACROMOLECULAR SCIENCE, REV. MACROMOL. CHEM. PHYS. 285-297 (1989)). Although conventional ¹³C NMR spectroscopy cannot determine the length of a long-chain branch in excess of six carbon atoms, there are other known techniques useful for quantifying or determining the presence of long-chain branches in ethylene-based polymers, such as ethylene/1-octene interpolymers. For those ethylene-based polymers wherein the ¹³C resonances of the comonomer overlap completely with the ¹³C resonances of the long-chain branches, either the comonomer or the other monomers (such as ethylene) can be isotopically labeled so that the long-chain branches can be distinguished from the comonomer. For example, a copolymer of ethylene and 1-octene can be prepared using ¹³C-labeled ethylene. In this case, the resonances associated with macromer incorporation will be significantly enhanced in intensity and will show coupling to neighboring ¹³C carbons, whereas the octene resonances will be unenhanced.

Alternatively, the degree of long-chain branching in ethylene-based polymers may be quantified by determination of the branching index. The branching index, g′, is typically 0.950 to 1.00. For particular ethylene-based polymers the lower limit on the branching index, g′, may be 0.950, 0.960, 0.970, 0.975, 0.980, 0.985, 0.990, 0.995, 0.997, or 0.999. Likewise, the upper limit on the branching index, g′, may be 0.960, 0.970, 0.975, 0.980, 0.985, 0.990, 0.995, 0.997, 0.999, or 1.00. Any combination lower and upper limits should be considered to be disclosed by the above limits on the branching index, e.g., 0.960 to 0.999, 0.985 to 0.995, 0.997 to 1.00, 0.999 to 1.00, etc. The branching index, g′, is defined by the following equation:

$${g}^{′} = \frac{{IV}_{Br}}{{IV}_{Lin}} {\vert}_{{M}_{w}}$$

where g′ is the branching index, IV_{Br} is the intrinsic viscosity of the ethylene-based polymer and IV_{Lin} is the intrinsic viscosity of a linear polyethylene control sample selected to the same weight average molecular weight and molecular weight distribution as the ethylene-based polymer, and in the case of copolymers and terpolymers, substantially the same relative molecular proportion or proportions of monomer units. For these purposes, the molecular weight and molecular weight distribution are considered “the same” if the respective values for the branched polymer and the corresponding linear polymer are within 10% of each other. Preferably, the molecular weights are the same and the MWD of the polymers are within 10% of each other. A method for determining intrinsic viscosity of polyethylene is described in 33 MACROMOLECULES 7489-7499 (2000). Intrinsic viscosity may be determined by dissolving the linear and branched polymers in an appropriate solvent, e.g., trichlorobenzene, typically measured at 135° C. Another method for measuring the intrinsic viscosity of a polymer is ASTM D-5225-98 Standard Test Method for Measuring Solution Viscosity of Polymers with a Differential Viscometer.

While any suitable polymerization method (including solution or slurry polymerization methods) may be used, the ethylene-based polymers of the present invention may be readily obtained via a continuous gas phase polymerization using supported catalyst comprising an activated molecularly discrete catalyst in the substantial absence of an aluminum alkyl based scavenger (e.g., triethylaluminum (TEAL), trimethylaluminum (TMAL), triisobutyl aluminum (TIBAL), tri-n-hexylaluminum (TNHAL), and the like).

Ethylene-based polymers of the invention are preferably made with zirconium transition metal metallocene-type catalyst systems. Non-limiting examples of metallocene catalysts and catalyst systems useful in practicing the present invention include those described in, U.S. Pat. No. 5,466,649, U.S. Pat. No. 6,090,740, U.S. Pat. No. 6,476,171, U.S. Pat. No. 6,225,426, and U.S. Pat. No. 7,951,873. Preferably, the catalyst system is a bis (alkyl-cyclopentadienyl) zirconium dihalide compound with methalumoxane or borane activator.

Supported polymerization catalyst may be deposited on, bonded to, contacted with, or incorporated within, adsorbed or absorbed in, or on, a support or carrier. In another embodiment, the metallocene is introduced onto a support by slurrying a pre-supported activator in oil, a hydrocarbon such as pentane, solvent, or non-solvent, then adding the metallocene as a solid while stirring. The metallocene may be finely divided solids. Although the metallocene is typically of very low solubility in the diluting medium, it is found to distribute onto the support and be active for polymerization. Very low solubilizing media such as mineral oil (e.g., Kaydol™ or Drakol™) or pentane may be used. The diluent can be filtered off and the remaining solid shows polymerization capability much as would be expected if the catalyst had been prepared by traditional methods such as contacting the catalyst with methylalumoxane in toluene, contacting with the support, followed by removal of the solvent. If the diluent is volatile, such as pentane, it may be removed under vacuum or by nitrogen purge to afford an active catalyst. The mixing time may be greater than 4 hours, but shorter times are suitable.

Typically in a gas phase polymerization process, a continuous cycle is employed where in one part of the cycle of a reactor, a cycling gas stream, otherwise known as a recycle stream or fluidizing medium, is heated in the reactor by the heat of polymerization. This heat is removed in another part of the cycle by a cooling system external to the reactor.

Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. The reactor pressure may vary from 100 psig (680 kPag) to 500 psig (3448 kPag), or in the range of from 200 psig (1379 kPag) to 400 psig (2759 kPag), or in the range of from 250 psig (1724 kPag) to 350 psig (2414 kPag). The reactor operated at a temperature in the range of 60° C. to 120° C., 60° C. to 115° C., 70° C. to 110° C., 70° C. to 95° C., or 85° C. to 95° C. The productivity of the catalyst or catalyst system is influenced by the main monomer partial pressure. The mole percent of the main monomer, ethylene, is from 25.0 to 90.0 mole percent, or 50.0 to 90.0 mole percent, or 70.0 to 85.0 mole percent, and the monomer partial pressure is in the range of from 75 psia (517 kPa) to 300 psia (2069 kPa), or 100 to 275 psia (689 to 1894 kPa), or 150 to 265 psia (1034 to 1826 kPa), or 200-250 psia (1378 to 1722 kPa), which are typical conditions in a gas phase polymerization process.

It may be beneficial in slurry or gas phase processes to operate in the substantial absence of or essentially free of any scavengers, such as triethylaluminum, trimethylaluminum, triisobutylaluminum, and tri-n-hexylaluminum and diethyl aluminum chloride and the like. Such processes are described in WO 96/08520.

Additionally, the use of a process continuity aid, while not required, may be desirable in any of the foregoing processes. Such continuity aids are well-known to persons of skill in the art and include, for example, metal stearates.

### Blends of Ethylene-Based Polymers

For improved cling performance of polyethylene films, it may be desirable to blend one or more “polyolefin additives” with the ethylene-based polymers of inventive films. Ethylene-based polymers described herein can be blended with polyolefin additives such as polyethylene homopolymer and copolymer compositions (e.g., LLDPE, HDPE, MDPE, LDPE, and other differentiated polyethylenes, and propylene based polymers), so called “polyalphaolefins”, and/or propylene-based copolymers. The ethylene-based polymer may be present in such blends in an amount of from 40 or 50 or 60 wt % to 99.9 wt % by weight of the blend, or by weight of the cling layer or film in which the blend resides. Preferably, upper limit on the amount of ethylene-based polymer in such blends may be 99.5 wt %, 99.0 wt %, 98.0 wt %, 97.0 wt %, 96.0 wt %, 95.0 wt %, 90.0 wt %, 85.0 wt %, 80.0 wt %, 75.0 wt %, or 70.0 wt %. The lower limit on the amount of ethylene-based polymer in such blends may be 70.0 wt %, 60.0 wt %, 50.0 wt %, or 40.0 wt %. The amount of ethylene-based polymer is based on the total weight of the polymer blend.

The ethylene-based polymer of the inventive film or cling layer may further comprise within the range from 5 or 10 wt % to 30 or 40 wt % of a linear low density polyethylene having an 1₂ within the range from 0.1 or 1.0 g/10 min to 3.0 or 5.0 g/10 min, with a density of less than 0.930 or 0.925 or 0.920 g/cm³.

Preferably, the ethylene-based polymer used for the cling layer may be blended with one or more propylene-based polymers (polymers having greater than 51 wt % propylene-derived units), preferably a propylene-based elastomer such as Vistamaxx™ propylene-based elastomers (ExxonMobil Chemical Co.). In addition to blends having the compositional limits described above, particularly useful blends comprise less than 40.0 wt % (e.g., 2.0 to 39.5 wt %, 5.0 to 35.0 wt %, 7.5 to 32.5 wt %, 10.0 to 30.0 wt %, 10.0 to 30.0 wt %, 25.0 to 35.0 wt %, 30.0 to 39.5 wt %, 35.0 to 35.0 wt %) propylene-based elastomer based on the weight of the blend or the cling layer or film in which it resides.

The propylene-based elastomer is a copolymer of propylene-derived units and units derived from at least one of ethylene or a C₄ to C₁₀ α-olefin. The copolymer may contain at least 60.0 wt % propylene-derived units of the propylene-based elastomer. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The propylene-based elastomer may comprise more than one comonomer. Preferred embodiments of a propylene-based elastomer having more than one comonomer include propylene-ethylene-octene, propylene-ethylene-hexene, and propylene-ethylene-butene polymers. In some embodiments where more than one comonomer derived from at least one of ethylene or a C₄ to C₁₀ α-olefin is present, the amount of one comonomer may be less than 5.0 wt % of the propylene-based elastomer, but the combined amount of comonomers of the propylene-based elastomer is 5.0 wt % or greater.

Preferably, the propylene-based elastomer is a copolymer of propylene and ethylene derived units. The propylene-based elastomer may comprise 5.0 to 25.0 wt %, preferably 8.0 to 22.5 wt %, or 9.0 to 20.0 wt %, or 12.0 to 24.0 wt %, or 12.0 to 22.0 wt % ethylene-derived units within the propylene-based elastomer. In some embodiments, the propylene-based elastomer consists essentially of units derived from propylene and ethylene, i.e., the propylene-based elastomer does not contain any other comonomer in an amount typically present as impurities in the ethylene and/or propylene feedstreams used during polymerization or an amount that would materially affect the heat of fusion, melting point, crystallinity, or melt flow rate of the propylene-based elastomer, or any other comonomer intentionally added to the polymerization process.

The propylene-based elastomer may have a triad tacticity of three propylene units, as measured by ¹³C NMR, of at least 75.0%, at least 80.0%, at least 82.0%, at least 85.0%, or at least 90.0%. Preferably, the propylene-based elastomer has a triad tacticity of 50.0 to 99.0%, 60.0 to 99.0%, more preferably 75.0 to 99.0% or 80.0 to 99.0%. In some embodiments, the propylene-based elastomer may have a triad tacticity of 60.0 to 97.0%.

The propylene-based elastomer has a heat of fusion (“H_{f}”), as determined by DSC, of 80.0 J/g or less, preferably 70.0 J/g or less, 50.0 J/g or less, or 35.0 J/g or less. The propylene-based elastomer may have a lower limit H_{f} of 0.5 J/g, 1.0 J/g, or 5.0 J/g. For example, the H_{f} value may be anywhere from 1.0, 1.5, 3.0, 4.0, 6.0, or 7.0 J/g, to 30.0, 35.0, 40.0, 50.0, 60.0, 70.0, 75.0, or 80.0 J/g.

The propylene-based elastomer may have a percent crystallinity, as determined according to the DSC procedure described herein, of 2.0 to 65.0%, preferably 0.5 to 40.0%, preferably 1.0 to 30.0%, and more preferably 5.0 to 35.0%, of isotactic polypropylene. The thermal energy for the highest order of propylene (i.e., 100% crystallinity) is estimated at 189 J/g. In some embodiments, the copolymer has crystallinity less than 40%, in the range of 0.25 to 25.0%, or 0.5 to 22.0% of isotactic polypropylene. Embodiments of the propylene-based elastomer may have a tacticity index m/r from a lower limit of 4 or 6 to an upper limit of 8 or 10 or 12. In some embodiments, the propylene-based elastomer has an isotacticity index greater than 0%, or within the range having an upper limit of 50.0% or 25.0%, and a lower limit of 3.0% or 10.0%.

The crystallinity of the propylene-based elastomer may be reduced by copolymerization of propylene with limited amounts of one or more comonomers selected from: ethylene, C₄ to C₂₀ α-olefins, and polyenes. In these copolymers, the amount of propylene-derived units present in the propylene-based elastomer ranges from an upper limit of 95.0 wt %, 94.0 wt %, 92.0 wt %, 90.0 wt %, or 85.0 wt %, to a lower limit of 60.0 wt %, 65.0 wt %, 70.0 wt %, 75.0 wt %, 80.0 wt %, 84.0 wt %, or 85.0 wt % of the propylene-based elastomer.

The propylene-based elastomer may have a single peak melting transition as determined by DSC. In one embodiment, the copolymer has a primary peak transition of 90° C. or less (e.g., 40 to 50° C.), with a broad end-of-melt transition of 110° C. or greater. The peak “melting point” (“Tₘ”) is defined as the temperature of the greatest heat absorption within the range of melting of the sample. However, the copolymer may show secondary melting peaks adjacent to the principal peak and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of 110° C. or less, 105° C. or less, 100° C. or less, 90° C. or less, 80° C. or less, or 70° C. or less. In one embodiment, the propylene-based elastomer has a Tₘ of 25 to 110° C., preferably 40 to 110° C., 60 to 110° C., or 70 to 105° C.

The propylene-based elastomer preferably has a density of 0.850 to 0.920 g/cm³, 0.860 to 0.900 g/cm³, preferably 0.860 to 0.880 g/cm³, at room temperature (23° C.) as measured per ASTM D1505.

The propylene-based elastomer may have a melt flow rate (“MFR”), as measured per ASTM D1238, 2.16 kg at 230° C., of at least 2 g/10 min. In one embodiment, the propylene-based elastomer has an MFR 2.0 to 20.0 g/10 min, 2.0 to 10.0 g/10 min, or 2.0 to 5.0 g/10 min.

The propylene-based elastomer may have an Elongation at Break of less than 2000%, less than 1000%, or less than 800%, as measured per ASTM D412.

The propylene-based elastomer typically has a weight average molecular weight (M_{w}) of 5.00×10³ to 5.00×10⁶ g/mol, preferably 1.00×10⁴ to 1.00×10⁶ g/mol, and more preferably 5.00×10⁴ to 4.00×10⁵ g/mol; a number average molecular weight (Mₙ) of 2.50×10³ to 2.50×10⁵ g/mol, preferably 1.00×10⁴ to 2.50X10⁵ g/mol, and more preferably 2.50×10⁴ to 2.00×10⁵ g/mol; and/or a z-average molecular weight (M_{z}) of 1.00×10⁴ to 7.00×10⁶ g/mol, preferably 8.00×10⁴to 7.00×10⁵ g/mol, and more preferably 1.00×10⁵ to 5.00×10⁵ g/mol. The propylene-based elastomer may have a molecular weight distribution (“MWD”) of 1.5 to 20, or 1.5 to 15, preferably 1.5 to 5.0, and more preferably 1.8 to 3.0, and most preferably 1.8 to 2.5.

Preferred propylene-based elastomers are available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins of the Netherlands). The particular grade(s) of commercially available propylene-based elastomer suitable for use in the invention can be readily determined using methods commonly known in the art.

Most preferably, the propylene-based elastomer is an elastomer having propylene-crystallinity, a melting point by DSC equal to or less than 105° C., and a H_{f} of from 5 J/g to 30 J/g. The propylene-derived units are present in an amount of 76 to 91 wt %, based on the total weight of the propylene-based elastomer. The ethylene-derived units are present in an amount of 9 to 18 wt %, for example, within a range from 9 or 10 or 12 or 14 wt % to 18 or 20 or 24 wt %, based on the total weight of the propylene-based elastomer. Other properties are as outlined above.

The propylene-based elastomer may comprise copolymers prepared according to the procedures described in WO 02/36651, U.S. Pat. No. 6,992,158, and/or WO 00/01745. Preferred methods for producing the propylene-based elastomer may be found in U.S. Pat. No. 7,232,871 and U.S. Pat. No. 6,881,800. The invention is not limited by any particular polymerization method for preparing the propylene-based elastomer, and the polymerization processes are not limited by any particular type of reaction vessel.

### Ethylene-Based Plastomer

The inventive film or cling layer may alternatively include within the range from 25 wt % or 30 wt % or 40 wt % to 60 wt % or 65 wt % or 70 wt % or 75 wt %, based on the total weight blend in the cling layer, of an ethylene polymer haying a density within a range from 0.855 g/cm³ to 0.910 g/cm³, preferably from 0.860 to 0.905 g/cm³, even more preferably from 0.865 g/cm³ to 0.890 g/cm³ (i.e., an ethylene-based pla.stornex). The remainder will then be the ethylene-based polymer described above and any other additives. Such ethylene-based plastomers comprise about 87 mol % to about 97.5 mol % of polymer units derived from ethylene and about 13 mol % to about 2.5 mol % of polymer units derived from an α-olefin comonomer, preferably a C₄ to C₁₂ α-olefin. Such ethylene-based plastomers are typically characterized as having a CDBI greater than 60, preferably greater than 80, and more preferably greater than 90, fractions having an M_{w} below 15,000 g/mol are ignored when determining CDBI as described in WO 93/03093, (columns 7 and 8), as well as in Wild et al, 20 J. POLY. SCI., POLY. PHYS. ED., 441 (1982) and U.S. Pat. No. 5,008,204. Preferred plastomers are also characterized by a DSC melting point curve that exhibits the occurrence of a single melting point peak occurring in the region of 50° C. to 110° C. (second melt rundown) and may have a M_{w} greater than 70,000 g/mol to less than 130,000 g/mol. Such plastomers have a heat of fusion (H_{f}) of greater than 75 J/g as determined by differential scanning calorimetry, and preferably less than 130.0 J/g, 125.0 J/g, 120.0 J/g, 110.0 J/g, or 100.0 J/g.

More preferred plastomers also have a molecular weight distribution (M_{w}/Mₙ) value less than 4.0, preferably from 1.1 to 3.5. Some preferred ethylene-based plastomers have a 1% secant modulus less than about 1.5×10⁴ and as low as about 8×10² psi or even less. Examples include ethylene-octene ethylene-hexene; and/or ethylene-butene polymers sold under the trade name Exact™ Plastomers (ExxonMobil Chemical Company), or Affinity™ Polyolefin Plastomers (Dow Chemical Company).

### Polyalphaolefins

As a polyolefin additive, so called “polyalphaolefins” may be added to the inventive films or cling layer of films described herein. In general polyalphaolefins (PA0s) are oligomers of α-olefins (also known as 1-olefins) and are often used as the base stock for synthetic lubricants. PAOs are typically produced by the polymerization of α-olefins, preferably linear α-olefins. A PAO may be characterized by any type of tacticity, including isotactic or syndiotactic and/or atactic, and by any degree of tacticity, including isotactic-rich or syndiotactic-rich or fully atactic. PAO liquids are described in, for example, U.S. Pat. No. 3,149,178; U.S. Pat. No. 4,827,064; U.S. Pat. No. 4,827,073; U.S. Pat. No. 5,171,908; and U.S. Pat. No. 5,783,531; and in SYNTHETIC LUBRICANTS AND HIGH-PERFORMANCE FUNCTIONAL FLUIDS, Leslie R. Rudnick & Ronald L. Shubkin, eds. 3-52 (Marcel Dekker, 1999). PAOs are Group 4 compounds, as defined by the American Petroleum Institute (API).

Useful PAOs may be made by any suitable means known in the art, and the invention is not herein limited by the manufacturing method. The PAOs may be prepared by the oligomerization of an α-olefin in the presence of a polymerization catalyst, such as a Friedel-Crafts catalyst (including, for example, AlCl₃, BF₃, and complexes of BF₃ with water, alcohols, carboxylic acids, or esters), a coordination complex catalyst (including, for example, the ethylaluminum sesquichloride and TiCl₄ system), or a homogeneous or heterogeneous (supported) catalyst more commonly used to make polyethylene and/or polypropylene (including, for example, Ziegler-Natta catalysts, metallocene or other single-site catalysts, and chromium catalysts). Subsequent to the polymerization, the PAO may be hydrogenated in order to reduce any residual unsaturation. PAO's may be hydrogenated to yield substantially (greater than 99 wt %) paraffinic materials. The PAO's may also be functionalized to comprise, for example, esters, polyethers, polyalkylene glycols, and the like.

In general, PAOs are high purity hydrocarbons with a paraffinic structure and a high-degree of side-chain branching. The PAO may have irregular branching or regular branching. The PAO may comprise oligomers or low molecular weight polymers of branched and/or linear alpha olefins. In one embodiment, the PAO comprises C₆ to C₂₀₀₀, or C₁₅ to C₁₅₀₀, or C₂₀ to C₁₀₀₀, or C₃₀ to C₈₀₀, or C₃₅ to C₄₀₀, or C₄₀ to C₂₅₀ oligomers of α-olefins. These oligomers may be dimers, trimers, tetramers, pentamers, etc. In another embodiment, the PAO comprises C₂ to C₂₄, preferably C₅ to C₁₈, more preferably C₆ to C₁₄, even more preferably C₈ to C₁₂, most preferably C₁₀ branched or linear α-olefins. In another embodiment, the PAO comprises C₃ to C₂₄, preferably C₅ to C₈, more preferably C₆ to C₁₄, most preferably C₈ to C₁₂ linear α-olefins (LAOs). Suitable olefins include ethylene, propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, and blends thereof. Oligomers of LAOs with only even carbon numbers between 6 and 18 (inclusive) are particularly preferred. Preferably C₂, C₃, and C₄ α-olefins (i.e., ethylene, propylene and 1-butene and/or isobutylene) are present in the PAO oligomers at an average concentration of 30 wt % or less, or 20 wt % or less, or 10 wt % or less, or 5 wt % or less; more preferably C₂, C₃, and C₄ α-olefins are not present in the PAO oligomers. Useful PAOs are described more particularly in, for example, U.S. Pat. No. 5,171,908 and U.S. Pat. No. 5,783,531.

Preferably, a single LAO is used to prepare the oligomers. In this case, a preferred embodiment involves the oligomerization of 1-decene, and the PAO is a mixture of oligomers (including, for example, dimers, trimers, tetramers, pentamers, and higher) of 1-decene. In another embodiment, the PAO comprises oligomers of two or more C₃ to C₁₈ LAOs (preferably C₅ to C₁₈ LAOs), to make “biopolymer” or “terpolymer” or higher-order copolymer combinations, provided that C₃ and C₄ LAOs are present at 10 wt % or less. In this case, a preferred embodiment involves the oligomerization of a mixture of 1-octene, 1-decene, and 1-dodecene, and the PAO is a mixture of oligomers (for example, dimers, trimers, tetramers, pentamers, and higher) of 1-octene/1-decene/1-dodecene “terpolymer”.

Preferably, the PAO comprises oligomers of a single α-olefin species having a carbon number of 5 to 24 (preferably 6 to 18, preferably 8 to 12, most preferably 10). In another embodiment, the PAO comprises oligomers of mixed a-olefins (i.e., involving two or more α-olefin species), each a-olefin having a carbon number of 3 to 24 (preferably 5 to 24, preferably 6 to 18, most preferably 8 to 12), provided that α-olefins having a carbon number of 3 or 4 are present at 10 wt % or less. In a particularly preferred embodiment, the PAO comprises oligomers of mixed a-olefins (i.e., involving two or more α-olefin species) where the weighted average carbon number for the α-olefin mixture is 6 to 14 (preferably 8 to 12, preferably 9 to 11).

In another embodiment of the PAO, the PAO comprises oligomers of one or more α-olefin with repeat unit formulas of —[CHR—CH₂]—, where R is a C₃ to C₁₈ saturated hydrocarbon branch. Preferably R is constant for all oligomers. In another embodiment, there is a range of R substituents covering carbon numbers from 3 to 18. Preferably R is linear, i.e., R is (CH₂)_{z}CH₃, where z is 2 to 17 (preferably 3 to 11, preferably 4 to 9). Optionally, R may contain one methyl or ethyl branch, i.e., R is (CH₂)ₘ[CH(CH₃)](CH₂)ₙCH₃ or (CH₂)ₓ[CH(CH₂CH₃)](CH₂)_{y}CH₃, where (m+n) is 1 to 15 (preferably 1 to 9, preferably 3 to 7) and (x+y) is 1 to 14 (preferably 1 to 8, preferably 2 to 6). Preferably m is greater than n. Preferably m is 0 to 15 (preferably 2 to 15, preferably 3 to 12, preferably 4 to 9) and n is 0 to 10 (preferably 1 to 8, preferably 1 to 6, preferably 1 to 4). Preferably x is greater than y. Preferably x is 0 to 14 (preferably 1 to 14, preferably 2 to 11, preferably 3 to 8) and y is 0 to 10 (preferably 1 to 8, preferably 1 to 6, preferably 1 to 4). Preferably the repeat units are arranged in a head-to-tail fashion with minimal heat-to-head connections.

The PAO may be atactic, isotactic, or syndiotactic. In one embodiment, the PAO has essentially the same population of meso [m] and racemic [r] dyads (preferably neither [m] nor [r] greater than 60%, preferably neither greater than 55%) as measured by ¹³C-NMR, making it atactic. In another embodiment, the PAO has more than 60% (preferably more than 70%, preferably more than 80%, preferably more than 90%) meso dyads [m]. In another embodiment, the PAO has more than 60% (preferably more than 70%, preferably more than 80%, preferably more than 90%) racemic dyads [r]. In one embodiment, [m]/[r] determined by ¹³C-NMR is between 0.9 and 1.1 in one embodiment, [m]/[r] is greater than 1 in another embodiment, and [m]/[r] is less than 1 in yet another embodiment.

Preferred PAOs have a “branching ratio” as defined in U.S. Pat. No. 4,827,064 and measured according to the method described therein, of 0.20 or less, preferably 0.19 or less, preferably 0.18 or less, preferably 0.17 or less, preferably 0.15 or less, preferably 0.12 or less, preferably 0.10 or less.

Some useful PAOs typically possess a number average molecular weight (Mₙ) in the range of 1.00×10² to 2.10×10⁴ g/mol or 3.00×10² to 1.50×10⁴ g/mol, or in the range of 2.00×10² to 1.00×10⁴, or 2.00×10² to 7.00×10³, or 6.00×10² to 3.00×10³, or 2.00×10² to 2.00×10³, or 2.00×10²-5.00×10²g/mol.

Some useful PAOs have a weight average molecular weight (M_{W}) of less than 1.00×10⁴g/mol, or less than 5.00×10³ g/mol, or less than 4.00×10³g/mol, or less than 2.00×10³ g/mol, or less than 5.00×10² g/mol. In some embodiments, the PAO may have an M_{w} of 5.00×10² g/mol or more, 1.00×10³ g/mol or more, or 2.00×10³ g/mol or more, or 2.50×10³ g/mol or more, or 3.00×10³ g/mol or more, or 3.50×10³ g/mol or more (e.g., 1.00×10³to 3.50×10³ g/mol, 1.00×10³ to 3.00×10³ g/mol, or 1.25×10³ to 2.50×10³g/mol). In other embodiments the PAO may have an M_{w} of 5.0×10² to 1.0×10⁴ g/mol, preferably 7.5×10² to 5.0×10³g/mol, preferably 1.0×10³ to 2.0×10³g/mol. In one or more embodiments, the PAO or blend of PAOs has a molecular weight distribution as characterized by the ratio of the weight- and number-averaged molecular weights (M_{w}/Mₙ) of 4 or less, or 3 or less, or 2.5 or less, or 2.3 or less, or 2.1 or less, or 2.0 or less, or 1.9 or less, or 1.8 or less. In other embodiments, the PAO or blend of PAOs has an M_{w}/Mₙ in the range of 1 to 2.5, preferably 1.1 to 2.3, or 1.1 to 2.1, or 1.1 to 1.9.

Some useful PAOs have a kinematic viscosity (“KV”) at 100° C., as measured by ASTM D445 at 100° C., of 3 cSt (1 cSt=1 mm²/s to 3,000 cSt, 4 to 1,000 cSt, 6 to 300 cSt, 8 to 125 cSt, preferably 8 to 100 cSt, preferably 10 to 60 cSt). In another embodiment, the PAO has a KV at 100° C. of 10 to 1000 cSt, preferably 10 to 300 cSt, preferably 10 to 100 cSt. In yet another embodiment, the PAO has a KV at 100° C. of 4 to 8 cSt. In yet another embodiment, the PAO has a KV at 100° C. of 1 to 3 cSt.

Preferred PAOs have a kinematic viscosity (“KV”) as measured by ASTM D445 at 25° C. of 5.0 to 1.5×10³ cSt, 5.0×10²to 1.0×10³ cSt, or 1.0×10² to 5.0×10² cSt.

PAO's may also have a viscosity index (“VI”), as determined by ASTM D2270, 90 to 400, or 120 to 350, or 130 to 250, or 100 to 180, or preferably 120 to 175, or 130 to 160.

The preferred PAO has a pour point of −100° C. to 0° C., preferably −100° C. to −10° C., preferably −90° C. to −15° C., −80° C. to −20° C. In another embodiment, the PAO or blend of PAOs has a pour point of −25 to −75° C., preferably −40 to −60° C.

The preferred PAO has a glass transition temperature (T_{g}) of −40° C. or less, preferably −50° C. or less, preferably −60° C. or less, preferably −70° C. or less, preferably −80° C. or less. In another embodiment, the PAO or blend of PAOs has a T_{g} of −50 to −120° C., preferably −60 to −100° C., preferably −70 to −90° C.

The preferred PAO has a flash point of 200° C. or more, preferably 210° C. or more, preferably 220° C. or more, preferably 230° C. or more, preferably between 240° C. and 290° C.

The preferred PAO also has a specific gravity (15.6/15.6° C., 1 atm/1 atm) of 0.79 to 0.90, preferably 0.80 to 0.89, preferably 0.81 to 0.88, preferably 0.82 to 0.87, 0.83 to 0.86 or 0.84 to 0.85.

Particularly preferred PAOs are those having (a) a flash point of 200° C. or more, preferably 210° C. or more, preferably 220° C. or more, preferably 230° C. or more; and (b) a pour point less than −20° C., preferably less than −25° C., preferably less than −30° C., preferably less than −35° C., preferably less than −40° C. and/or a KV at 100° C. of 8cSt or more, preferably 10 cSt or more, preferably 35 cSt or more, preferably 40 cSt or more, preferably 50 cSt or more.

Further preferred PAOs have a KV at 100° C. of at least 5 to 70 cSt, particularly 10 to 50 cSt; KV at 25° C. of 0.5×10² to 5.0×10² cSt, particularly 1.0×10² to 5.0×10² cSt; a VI of 100 to 180, or preferably 120 to 175, or 130 to 160; a pour point of −25 to −75° C., preferably −40 to −60° C.; and a specific gravity preferably 0.82 to 0.87, 0.83 to 0.86 or 0.84 to 0.85.

The PAO may be comprised of one or more distinct PAO components. In one embodiment, the PAO is a blend of one or more oligomers with different compositions (e.g., different a-olefin(s) were used to make the oligomers) and/or different physical properties (e.g., KV, pour point, VI, and/or T_{g}).

Desirable PAOs are available as SpectraSyn™ and SpectraSyn Ultra™ (previously sold under the SHF and SuperSyn™ tradenames) from ExxonMobil Chemical Company (Houston, Tex., USA). Other useful PAOs include Synfluid™ available from ChevronPhillips Chemical Company (Pasadena, Tex., USA), Durasyn™ available from Innovene (Chicago, Ill., USA), Nexbase™ available from Neste Oil (Keilaniemi, Finland), and Synton™ available from Chemtura Corporation (Middlebury, Conn., USA). The percentage of carbons in chain-type paraffinic structures (C_{P}) is close to 100% (typically greater than 98% or even 99%) for PAOs.

Exemplary combinations of polyolefin additives and ethylene-based polymers for the cling layer or films includes a blend comprising within the range from 50 wt % to 70 wt % of the ethylene-based polymer, within the range from 20 wt % to 40 wt % of a LLDPE, and within the range from 2 wt % to 12 wt % of a propylene-based elastomer. Another exemplary combination of polyolefin additives and ethylene-based polymers includes a blend comprising within the range from 80 wt % to 98 wt % of the ethylene-based polymer and within the range from 2 wt % to 20 wt % of the propylene-based elastomer. Yet another exemplary combination of polyolefin additives and ethylene-based polymers includes a blend comprising within the range from 30 wt % to 50 wt % of the ethylene-based polymer and within the range from 50 wt % to 70 wt % of an ethylene-based plastomer. Yet another exemplary combination of polyolefin additives and ethylene-based polymers includes a blend comprising within the range from 60 wt % to 90 wt % of the ethylene-based polymer and within the range from 10 wt % to 40 wt % of a PAO. Other combinations based on adding both PAO and the propylene-based elastomer or both PAO and the ethylene-based plastomer are also possible, within any number of ranges as described herein. In any preferred ranges stated for the polyolefin additive(s), the remainder of the blend or composition of the cling layer will be the ethylene-based polymer(s). A particularly preferred example is a blend of a PAO and propylene-based elastomer in the film or cling layer with the ethylene-based polymer within the range from 60% to 95 wt %, the propylene-based elastomer within the range from 30% to 4.5 wt %, and PAO within the range from 10% to 0.5 wt %.

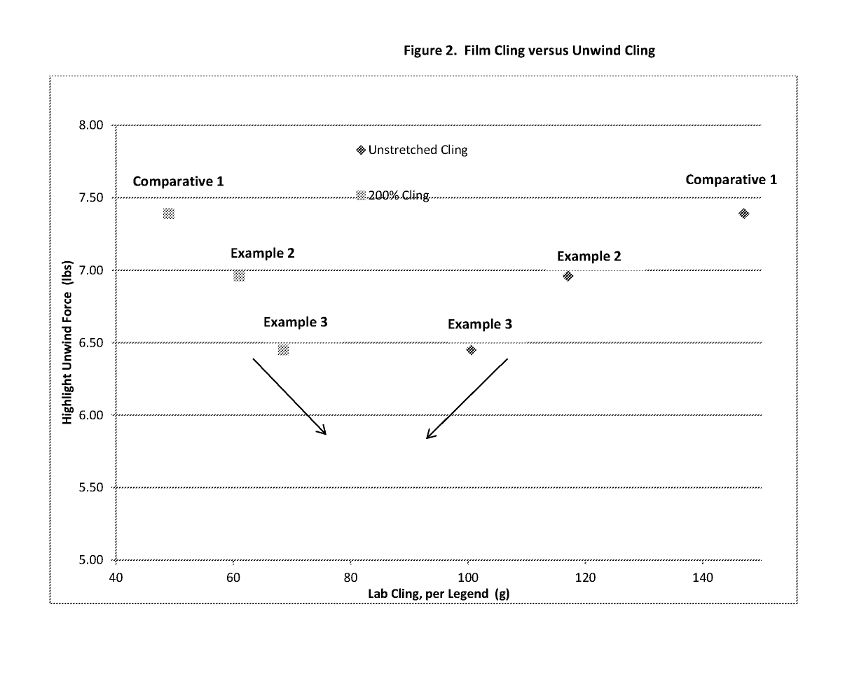

The polyolefin additive can be added in an amount, identity, or both such that the cling and blocking properties of the film that comprises the cling layer can be tailored to suit certain needs. This is shown graphically with reference to FIG. 2, where the Highlight Unwind Force goes down for both the un-Stretched and Stretched films upon adjusting the polyolefin additive with the ethylene-based polymer. Thus, the polyolefin additive may be adjusted so that as the film is stretched, the Cling (grams) is approaching or equal to the value for the un-Stretched Cling. Ultimately, the adjustment may be such that the Cling at 200% Stretch is less than the un-Stretched cling. This is another way of expressing the unique Cling Retention of the films, which desirably approach 70% or 80% or 90% or 95% or 100%. Stated another way, the Cling Retention of the inventive film comprising the cling layer is within a range from 40% or 45% or 50% to 70% or 75% or 80% or 85% or 90% or 95%.

Films from the Ethylene-Based Polymer or Polymer Blends

The inventive films preferably comprise (or consist essentially of) the ethylene-based polymer or ethylene-based polymer and blends with polyolefin additive(s). More preferably, the inventive films comprise a cling layer and one or more other layers such as polypropylene (PP), LLDPE, HDPE, etc., to form a multi-layered film. The “cling layer” is the layer of the film that will make contact with an article to be covered or wrapped by the film, or will make contact with itself on another part of the film, or on the back-side (opposite side of the film from the cling layer). By “consisting essentially of” what is meant is that the film or film layer may include common film additives (e.g., antistatic agents, antioxidants, cavitating agents, colorants, etc.) to a level of no more than 5 wt % that do not substantially influence its overall performance, that is, it's performance is still within the claimed parameters.

The inventive films, preferably multilayered films that include a cling layer can be made by any suitable method known, and is preferably made by co-extruding the three layers together in the desired compositions and thicknesses. Examples of methods of making the films include a tentered or blown process, LISIM™, and others. Further, the working conditions, temperature settings, lines speeds, etc. will vary depending on the type and the size of the equipment used. Nonetheless, described generally here is one method of making the films described throughout this specification. The various materials that make up the film layers are melt blended and coextruded, such as through a 3, 4, 5, 7-layer or more die head, into the desired film structure. A preferred method of making the films described herein is by cast extrusion or blown film extrusion, both of which are well known in the art, most preferably, the cast film process.

Typically, blown film extrusion is carried out vertically upwards, however, horizontal and downward extrusion processes are now becoming more common. This procedure generally consists of four main steps:
1. The polymer material starts in a pellet form, which are successively compacted and melted to form a continuous, viscous liquid. This molten plastic is then forced, or extruded, through an annular die.
2. Air is injected through a hole in the center of the die, and the pressure causes the extruded melt to expand into a bubble. The air entering the bubble replaces air leaving it, so that even and constant pressure is maintained to ensure uniform thickness of the film.
3. The bubble is pulled continually upwards from the die and a cooling ring blows air onto the film. The film can also be cooled from the inside using internal bubble cooling. This reduces the temperature inside the bubble, while maintaining the bubble diameter.
4. After solidification at the frost line, the film moves into a set of nip rollers which collapse the bubble and flatten it into two flat film layers. The puller rolls pull the film onto windup rollers. The film passes through idler rolls during this process to ensure that there is uniform tension in the film. Between the nip rollers and the windup rollers, the film may pass through a treatment center, depending on the application. During this stage, the film may be slit to form one or two films, or surface treated.

In the cast extrusion process, the various polyolefins that make up the layers may be extruded in a molten state through a flat die and then cooled. Alternatively, the copolymers may be extruded in a molten state through an annular die and then blown and cooled to form a tubular film. The tubular film may be axially slit and unfolded to form a flat film. The films of the invention may be unoriented, uniaxially oriented or biaxially oriented. Physical properties of the film may vary depending on the film forming techniques employed.

Multiple-layer films may be formed by methods well known in the art. If all layers are polymers, the polymers may be coextruded through a coextrusion feed-block and die assembly to yield a film with two or more layers adhered together but differing in composition. Multiple-layer films may also be formed by extrusion coating whereby a substrate material is contacted with the hot molten polymer as the polymer exits the die. For instance, an already formed polypropylene film may be extrusion coated with a copolymer film as the latter is extruded through the die. Multiple-layer films may also be formed by combining two or more single layer films prepared as described above. The total thickness of multilayer films may vary based upon the application desired. A total unstretched film thickness of 5-60 microns, and preferably from 8 to 25 microns, and most preferably from 5 to 20 microns is suitable for most applications.

The film's properties depend on the identity of the cling layer, the other film's layers, and the processing conditions used to make the films: mainly, draw (MD and TD), processing time and strain rate, as well as temperature and pressure profiles though out the extrusion train. Two useful factors to determine the suitability of a particular polyethylene resin or blend for blown or cast film are extrusion, including the maximum attainable rate of film manufacture, and mechanical properties of the formed film.

The inventive films are characterized by having improved cling as measured by its “Cling Retention” and/or “Parallel Cling Force” for the film or film that includes the cling layer. Thus, the invention includes a stretch cling film having Cling Retention greater than 50%, 60%, or 70%, said film comprising a cling layer comprising an ethylene-based polymer having an I₂ within the range from 5 to 15.0 or 20.0 or 25.0 g/10 min, and I₂₁/I₂ within the range from 9.0 or 12.0 or 15.0 to 40.0. Described another way, the inventive film is a multilayered stretch cling film having Cling Retention greater than 50% or 60% or 70%, wherein the film comprises a cling layer comprising an ethylene-based polymer having (a) a melt index I₂ within the range 5.0 to 25.0 g/10 min, (b) a melt index ratio, I₂₁/I₂ within the range of 9.0 to 40.0, and (c) a density within the range from 0.910 to 0.930 g/cm³.

In any case, the inventive film preferably comprises at least a cling layer, the film having a Parallel Cling Force of less than 200 g (or as otherwise stated herein) at 0% stretch, and greater than 50 grams at 200% stretch (or as otherwise stated herein), the cling layer comprising an ethylene-based polymer having a melt index, I₂, within the range from 5.0 or 6.0 to 10.0 or 15.0 or 20.0 or 25.0 g/10 min; a high-load melt index, I₂₁, within the range from 80.0 to 160.0 g/10 min; a melt index ratio (I₂₁/I₂) within the range from 9.0 or 12.0 or 15.0 to 40.0; and a density within the range from 0.910 to 0.930 g/cm³.

More preferably, the cling layer further comprises (or consists essentially of) within the range from 4 or 6 or 8 wt % to 12 or 16 or 20 or 25 wt % of one or more polyolefin additive(s), wherein the polyolefin additive is a propylene-based elastomer, a polyalphaolefin, or a combination thereof. Most preferably, the cling layer comprises within the range from 50 or 60 or 70 or 75 wt % to 90 or 94 or 96 wt % of the ethylene-based polymer. Preferably, the inventive film or cling layer comprises within the range from 4 or 6 or 8 wt % to 12 or 16 or 20 or 25 wt % of a polyolefin additive, wherein the polyolefin additive is a propylene-based elastomer, a polyalphaolefin, an ethylene-based plastomer, or a combination thereof. The inventive films may also include other polyethylenes. Preferably, the cling layer further comprises within the range from 5 or 10 wt % to 20 or 30 or 40 wt % of a linear low density polyethylene having an 1₂ within the range from 0.1 g/10 min to 5.0 g/10 min.

The inventive films or multi-layered films having the inventive cling layer demonstrate an increased cling as the film is stretched relative to prior art films. Prior art films tend to lose their “cling” ability when stretched, but the inventive films retain or even have improved cling when stretched. This is demonstrated by the measurement of the Parallel Cling Force of the films. The inventive films have a Parallel Cling Force at 0% stretch (“un-stretched”) within the range from 50 or 60 or 80 g to 110 or 120 or 130 or 140 or 200 or 300 g, or greater than 100 g or 150 g or 200 g, and a Parallel Cling Force at 200% stretch (or “200% Stretched Cling”) within the range from 30 or 40 or 50 g to 110 or 120 or 140 or 200 or 300 g, or greater than 40 or 50 or 60 or 80 or 100 g. The inventive films can also be described as having an upper limit Parallel Cling Force value, so for example, this may be expressed as the Parallel Cling Force at 0% stretch being less than 200 g or 150 g or 130 g, or 120 g or 100 g, while the Parallel Cling Force at 200% stretch is less than 100 g or 80 g or 60 g. Desirably, the inventive films have more “cling” when they are stretched, thus an enhanced stretch-cling property.

In addition to its advantageous cling properties, the inventive films have a number of properties that make them suitable as a stretch cling film. Preferably, the MD 1% secant modulus is at least 12 kpsi, or within a range of from 12k or 13 k or 14 kpsi to 20 k or 22 k or 25 kpsi; and the TD 1% secant modulus is preferably at least 14 kpsi, or within a range of from 14k or 16 k or 18 kpsi to 22 k or 24 k or 26 kpsi. Also, the MD tensile yield strength is greater than 800 psi, or preferably within the range of from 800 or 1000 psi to 1400 or 1600 or 1800 psi; and the TD tensile yield strength is greater than 700 psi, or preferably within the range from 700 or 900 psi to 1200 or 1400 psi. Preferably, the MD Elmendorf Tear of the inventive films is greater than 200 g/mil, or within the range from 100 or 200 or 250 g/mil to 350 or 400 or 450 or 500 g/mil; and the TD Elmendorf Tear is greater than 400 g/mil, or within the range from 350 or 400 or 450 g/mil to 600 or 650 or 700 or 800 g/mil. The Dart Drop of the films is at least 150 or 160 or 170 or 180 g/mil, and the films have a low Haze of less than 10 or 6 or 4%. Finally, the Highlight Ultimate stretch is greater than 350%, 365%, 380%, or within a range from 100% or 150% or 200% to 350 or 400 or 450%.

There are many potential applications of films produced from the present copolymers. These films can be made into other forms, such as tape, by any one of a number of well-known cutting, slitting, and/or rewinding techniques. They may be useful as sealing or oriented films. Typical articles suitable for bundling, packaging and unitizing include various foodstuffs (canned or frozen), rolls of carpet, liquid containers and various like goods normally containerized and/or palletized for shipping, storage, and/or display. The films may also be used in surface protection applications with or without stretching. The films are effective, especially in the temporary protection, of surfaces during manufacturing, transportation, etc. The surfaces of the film of this invention can be modified by such known and conventional post-forming techniques such as flame treatment, corona discharge, chemical treatment, etc.

The various descriptive elements and numerical ranges disclosed herein for the inventive films can be combined with other descriptive elements and numerical ranges to describe the invention; further, for a given element, any upper numerical limit can be combined with any lower numerical limit described herein. The features of the invention are demonstrated in the following non-limiting examples.

### EXAMPLES

Exemplary inventive films were made from an ethylene-based polymer (or “αPE”) as produced and described in U.S. Ser. No. 61/823,039 filed in Mar. 14, 2013, having an Attorney Docket No. 2013EM146, which in turn, cites U.S. Pat. No. 6,090,740 for the synthesis of the inventive ethylene-based polymer used herein. The inventive ethylene-based polymer used herein is a metallocene catalyzed copolymer of ethylene and 1-hexene derived units produced in a gas phase process, resulting in a linear low density (0.918 g/cm³) polyethylene having a melt index (I₂) of 7.5 g/10 min, and I₂₁ of 125-130 g/10 min, with a resulting I₂₁/I₂ of 16-17 under the particular polymerization conditions. The ethylene-based polymer has an MWD (Mw/Mn) of 3.0 (±0.2).

Inventive films were made on a commercial cast line running nominal 900 fpm line speed. A multi-layered film was made having polyolefin interior layers, primarily LLDPE resins with a LLDPE core and a polyolefin sub-layer between the inventive cling layer and core layer, with the “A” or “cling layer” being 10% of the total film structure. The equipment used to make the films were Gloucester Equipment Company film line. Cling layer resins were processed in an extruder which ran LL3003 (nominal I₂ of 3.2 g/10 min (190/2.16), 0.918 g/cm³ 1-hexene copolymer available from ExxonMobil Chemical) with 7 wt % Vistamaxx propylene-based elastomer (“VMX”) 6102 (nominal MFR of 3 g/10 min (230/2.16), 16 wt % ethylene derived units, 1550 psi flexural modulus) propylene-based elastomer available from ExxonMobil Chemical) as a control “polyolefin additive” at melt temperature of 530° F. (277° C.). Before transition to the 7.5 MI αPE formulation, melt temperature settings were lowered to target 490° F. (254° C.) due to the higher MI of αPE. The αPE was processed in an extruder with the cling layer again with 7 wt % Vistamaxx 6102 propylene-based elastomer. There were no other changes to film compositions or settings. Nominal 12 micron films were made at routine processing conditions. Note: final extruder zones were set 35° F. (2° C.) lower for the inventive films. Zones 4/5/6 were at 490° F. (254° C.) versus normal 525° F. (274° C.).

In particular, the A Extruder was the cling layer extruder. It is 2.5 inch diameter and a 30/1 L/D. It has a 75 HP drive motor. Resins used in the other extruders are polyolefin resins generally with I₂ (Melt Index) between 2.0 and 5.0 g/10 min, commonly used in stretch cling type films. Other film processing details are given in Table 1.

TABLE 1
Cast Film manufacturing conditions

| | Sample ID | | |
|---|---|---|---|
| | Comparative 1 | Inventive 2 | Inventive 3 |
| | Cling layer wt % components | | |
| | | 7% VMX 6102 | |
| | 7% VMX 6102 | 33% LL3003 | 7% VMX 6102 |
| | 93% LL3003 | 60% αPE | 93% αPE |
| Extruder A (Cling | | | |
| layer) | | | |
| RPM | 67.8 | 66.2 | 65.0 |
| % of total | 9.9 | 10.0 | 10.0 |
| Pressure 1 (psi) | 3320 | 3190 | 2980 |
| Pressure 2 (psi) | 3280 | 3100 | 2920 |
| Melt Temp ° F. | 530 (277) | 490 (254) | 487 (253) |
| (° C.) | | | |
| Horse Power | 12 | 12 | 11 |
| Extruder C (Core) | | | |
| RPM | 67.1 | 64.8 | 65.1 |
| % of total | 39.1 | 39.0 | 38.9 |
| Pressure 1 (psi) | 6150 | 6210 | 6160 |
| Pressure 2 (psi) | 2780 | 2780 | 3080 |
| Melt Temp ° F. | 543 (284) | 542 (283) | 541 (283) |
| (° C.) | | | |
| Horse Power | 95 | 95 | 96 |
| Primary (FPM) | 874 | 873 | 868 |
| Secondary (FPM) | 878 | 877 | 872 |

TABLE 2
Multi-layered cast film test results

| | Sample ID | | |
|---|---|---|---|
| | Comparative 1 | Inventive 2 | Inventive 3 |
| | Cling layer wt % components | | |
| | | 7% VMX 6102 | |
| | 7% VMX 6102 | 33% LL3003 | 7% VMX 6102 |
| | 93% LL3003 | 60% αPE | 93% αPE |
| Gauge Mic (mils) | | | |
| Average | 0.54 | 0.52 | 0.53 |
| Low | 0.45 | 0.44 | 0.48 |
| High | 0.61 | 0.58 | 0.61 |
| Range (%) | 29.6 | 26.9 | 24.5 |
| 1% Secant (psi) | | | |
| MD | 17,254 | 17,454 | 18,564 |
| TD | 19,726 | 20,516 | 21,547 |
| Tensile | | | |
| Yield Strength (psi) | | | |
| MD | 1,362 | 1,306 | 1,217 |
| TD | 1,135 | 1,119 | 984 |
| Elongation @ Yield | | | |
| (%) | | | |
| MD | 9.6 | 7.8 | 7.1 |
| TD | 7.9 | 6.4 | 5.6 |
| Tensile Strength (psi) | | | |
| MD | 7,889 | 7,912 | 7,614 |
| TD | 5,982 | 5,726 | 5,241 |
| Elongation @ Break | | | |
| (%) | | | |
| MD | 519 | 549 | 541 |
| TD | 685 | 672 | 652 |
| Elmendorf Tear | | | |
| MD (g/mil) | 305 | 312 | 297 |
| TD (g/mil) | 580 | 603 | 553 |

TABLE 3
Multi-layered film test results

| Sample ID | Comparative 1 | Inventive 2 | Inventive 3 |
|---|---|---|---|
| Haze (%) | 1.3 | 2.1 | 1.8 |
| Gloss (GU) | | | |
| MD | 89 | 81 | 84 |
| TD | 88 | 81 | 84 |
| Dart Drop | | | |
| Phenolic Method A | | | |
| (g) | 101 | 95 | 96 |
| (g/mil) | 187 | 183 | 181 |
| Puncture | | | |
| Peak Force (lbs/mil) | 9.6 | 10.6 | 12.4 |
| Break Energy (in-lbs/mil) | 34.2 | 39.7 | 49.5 |
| Cling (avg of 2) | | | |
| Cling Retention (200%/0%) | 0.33 | 0.52 | 0.69 |
| Cling Retention (%) Cling | 33.3 | 52.1 | 68.8 |
| Parallel Force(g): | | | |
| 0% | 147 | 117 | 100.5 |
| 100% | 65 | 75 | 69 |
| 200% | 49 | 61 | 68.5 |
| Highlight Testing (avg of 2) | | | |
| HL Ultimate | | | |
| % Stretch | 364 | 389 | 394.2 |
| Max Force (lbs) | 47.8 | 49.6 | 48.1 |
| Unwind Force (lbs) | 7.4 | 7.0 | 6.5 |
| HL Puncture Force/ | | | |
| # failures | | | |
| @200% | 5.6/0 | 5.7/0 | 5.8/0 |
| @250% | 4.6/0 | 6.2/0 | 6.1/0 |
| @300% | 5.4/1 | 6.7/0 | 5.8/1 |
| @350% | 2.2/2 | 5.1/1 | 3.1/2 |

The inventive films were characterized as follows:

Gauge, reported in mils, was measured using a Measuretech Series 200 instrument. The instrument measures film thickness using a capacitance gauge. For each film sample, ten film thickness datapoints were measured per inch of film as the film was passed through the gauge in a transverse direction. From these measurements, an average gauge measurement was determined and reported.

Elmendorf Tear, reported in grams (g) or grams per mil (g/mil), was measured as specified by ASTM D-1922.

Tensile Strength at Yield, reported in pounds per square inch (lb/in² or psi), was measured as specified by ASTM D-882.

Tensile Strength at Break, reported in pounds per square inch (lb/in² or psi), was measured as specified by ASTM D-882.

Tensile Strength at 50%, 100%, and/or 200% Elongation, reported in pounds per square inch (lb/in² or psi), was measured as specified by ASTM D-882.

Ultimate Tensile Strength, reported in pounds per square inch (lb/in² or psi), was measured as specified by ASTM D-882.

Tensile Energy, reported in inch-pounds (in-lb), was measured as specified by ASTM D-882.

Elongation at Yield, reported as a percentage (%), was measured as specified by ASTM D-882.

Elongation at Break, reported as a percentage (%), was measured as specified by ASTM D-882.

1% Secant Modulus (M), reported in pounds per square inch (Ib/in² or psi), was measured as specified by ASTM D-882.

Haze, reported as a percentage (%), was measured as specified by ASTM D-1003.

Gloss, a dimensionless number, was measured as specified by ASTM D-2457 at 45°.

Melt Index, I₂, reported in grams per 10 minutes (g/10 min), refers to the melt flow rate measured according to ASTM D-1238, condition E.

High Load Melt Index, I₂₁, reported in grams per 10 minutes (g/10 min), refers to the melt flow rate measured according to ASTM D-1238, condition F. Melt Index Ratio, a dimensionless number, is the ratio of the high load melt index to the melt index, or I₂₁/I₂.

Density, reported in grams per cubic centimeter (g/cm³), was determined using chips cut from plaques compression molded in accordance with ASTM D-1928 Procedure C, aged in accordance with ASTM D-618 Procedure A, and measured as specified by ASTM D-1505.

Dart F₅₀, or Dart Drop Impact or Dart Drop Impact Strength (DIS), reported in grams (g) and/or grams per mil (g/mil), was measured as specified by ASTM D-1709, method A, unless otherwise specified.

Puncture. A probe puncture energy test was completed using an Instron Universal tester that records a continuous reading of the force (stress) and penetration (strain) curve. A 6 inch by 6 inch (15 cm by 15 cm) film specimen was securely mounted to a compression load cell to expose a test area 4 inches in diameter (10 cm). Two HDPE slip sheets each 2 inches by 2 inches (5 cm by 5 cm) and each approximately 0.25 mils (6.35 82 m) thick were loosely placed on the test surface. A ¾ inch (1.875 cm) diameter elongated matte finished stainless steel probe, traveling at a constant speed of 10 inch/minute (35 cm/min) was lowered into the film, and a stress/strain curve was recorded and plotted. The “puncture force” was the maximum force (pounds) encounter or pounds per mil (lb/mil) encountered. The machine was used to integrate the area under the stress/strain curve, which is indicative of the energy consumed during the penetration to rupture testing of the film, and is reported as “puncture energy” (inch pounds) and/or inch-pounds per mil (in-lb/mil). The probe penetration distance was not recorded in these tests, unless specifically states to the contrary.

Cling is reported as the force in grams required to partially peel apart two strips of film. A first film strip is attached to a 30 (degree) inclined plane with the outside surface (slip) facing upward. A second 1″×8″ strip is placed on top of the first strip with the inside surface (cling) facing downward. Pressure is applied to the second strip to cause the two strips to stick together. If an evaluation of cling under stretched conditions is desired, both film strips are pre-stretched and allowed to relax before testing. The end of the second strip at the base of the inclined plane is attached, by clip and string, to an apparatus which can exert a strain at a constant rate (Instron 1130). The two strips are then pulled apart at a crosshead speed of 10 cm/min until the aforementioned string is parallel with the base of the inclined plane. The force at this point is reported as “Cling”. These values are dependent on the average thickness of the film, and the values reported herein are those of the Example Inventive cast films. Films may be stretched or not stretched. If films are stretched, then both film strips are stretched manually and allowed to relax before testing. Cling values are reported by % stretch for example, Cling at 200% stretch. Cling retention is 200% Cling/un-Stretched Cling as a “% Cling Retention”.

Highlight Ultimate Stretch, reported as a percentage, and Highlight Ultimate Stretch Force, reported in pounds (lb), were measured by a Highlight Stretch tester using a method consistent with Highlight recommended machine settings and normal industry practices. Results are reported as an average of three tests unless otherwise noted. Highlight film roll unwind may also be measured during Ultimate testing. It is reported as lbs required to unwind the film roll. This value can indicate film roll blocking, rolls that may be difficult to unwind.

Highlight Puncture Force, reported in pounds (lb), was measured by a Highlight Stretch tester using a method consistent with Highlight recommended machine settings. Results are reported as an average of two tests unless otherwise noted.

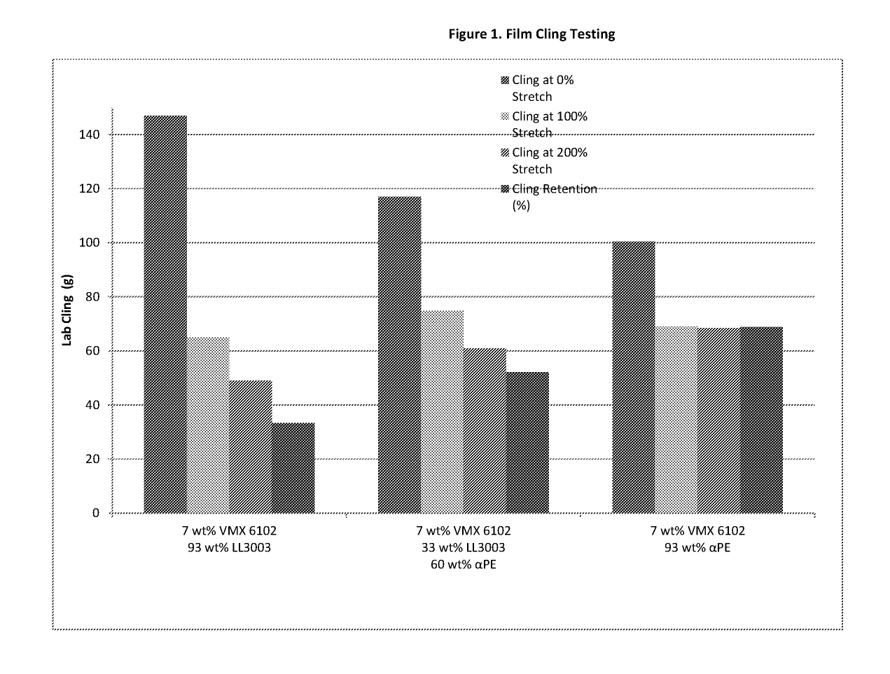

Results of film characterization are summarized in Tables 2 and 3, and some data shown graphically in FIGS. 1 and 2, to show the improved cling properties, or lower cling, at no stretch (0%), representing film coming off the film roll, and high stretch (200%), representing film after having been stretched in labs testing to simulate film use around materials to be packaged or contained. Values of Cling Retention are in %=(100·200% Cling)/0% Cling. As can be seen in FIG. 2, the stretch properties of the inventive films demonstrate a “Cling Retention” feature that is desirable, that is, the films have less cling when at produced and superior Cling Retention as they are stretched. Cling Retention in Table 3 is calculated as the cling percentage remaining after stretching from 0% to 200% stretch, a range of commercial interest. Higher Cling Retention is desirable as this allows required cling for the stretched film with a much lower cling for the “as produced” 0% stretch film roll. This lower un-Stretched Cling characteristic gives easier film roll unwind, as shown in Table 3. This lower “as produced” cling may mitigate film roll blocking and/or allow safe operation at higher cling levels needed for certain higher performance applications.

Now, having described the various features of the inventive films and/or the cling layer of the inventive films, described herein in numbered paragraphs is:
P1. A stretch cling film having Cling Retention greater than 50%, or 60%, or 70% comprising a cling layer comprising an ethylene-based polymer wherein the film Parallel Cling Force at 200% is greater than 50 g, or 60 g, or 70 g.
P.2 The stretch cling film of paragraph 1, having Cling Retention greater than 50%, 60%, or 70% comprising an ethylene-based polymer having an I₂ within the range from 5 to 15.0 or 20 or 25 g/10 min, and I₂₁/I₂ within the range from 9.0 or 12.0 or 15.0 to 40.0.
P.3 The stretch cling film of paragraphs 1 or 2, wherein the film comprises a cling layer that comprises (or consists essentially of) a polyolefin additive and an ethylene-based polymer.
P.4 The stretch cling film of any one of the previous numbered paragraphs, having a

Parallel Cling Force at 0% stretch within the range from 50 or 60 or 80 grams to 110 or 120 or 130 or 140 grams, and a Parallel Cling Force at 200% stretch within the range from 30 or 40 or 50 grams to 110 or 120 or 140 grams.
P.5 The stretch cling film of any one of the previous numbered paragraphs, wherein the cling layer comprises within the range from 50 or 60 or 70 or 75 wt % to 90 or 94 or 96 wt % of the ethylene-based polymer.
P.6 The stretch cling film of any one of the previous numbered paragraphs, wherein the cling layer further comprises within the range from 4 or 6 or 8 wt % to 12 or 16 or 20 or 25 wt % (for the elastomer and PAO) or from 25 wt % to 75 wt % (for the ethylene-based elastomer) of a polyolefin additive, wherein the polyolefin additive is a propylene-based elastomer, a polyalphaolefin, an ethylene-based plastomer, or a combination thereof; most preferably, the propylene-based elastomer.
P.7 The stretch cling film of any one of the previous numbered paragraphs, wherein the cling layer further comprises within the range from 5 or 10 wt % to 20 or 30 or 40 wt % of a linear low density polyethylene having an 1₂ within the range from 0.1 g/10 min to 5.0 g/10 min.
P.8 The stretch cling film of any one of the previous numbered paragraphs, wherein the MD 1% secant modulus within a range of from 12 k or 13 k or 14 kpsi to 20 k or 22 k or 25 kpsi; and the TD 1% secant modulus within a range of from 14 k or 16 k or 18 kpsi to 22 k or 24 k or 26 kpsi.
P.9 The stretch cling film of any one of the previous numbered paragraphs, wherein the

MD tensile yield strength is within the range of from 800 or 1000 psi to 1400 or 1600 or 1800 psi; and the TD tensile yield strength is within the range from 700 or 900 psi to 1200 or 1400 psi.
P.10 The stretch cling film of any one of the previous numbered paragraphs, wherein the

MD Elmendorf Tear is within the range from 100 or 200 or 250 g/mil to 350 or 400 or 450 or 500 g/mil; and the TD Elmendorf Tear is within the range from 350 or 400 or 450 g/mil to 600 or 650 or 700 or 800 g/mil.
P.11 The stretch cling film of any one of the previous numbered paragraphs, wherein the film has a Parallel Cling Force of less than 200 grams at 0% stretch and greater than 50 grams at 200% stretch.
P.12 The stretch cling film of any one of the previous numbered paragraphs, comprising at least a cling layer, the film having a Parallel Cling Force of less than 200 grams at 0% stretch and greater than 50 grams at 200% stretch, the cling layer comprising the ethylene-based polymer having:
   a) a melt index, I₂, within the range from 5.0 to 15.0 or 20.0 or 25.0 g/10 min;
   b) a high-load melt index, I₂₁, within the range from 80.0 to 160.0 g/10 min;
   c) a melt index ratio (I₂₁/I₂) within the range from 9.0 or 12.0 or 15.0 to 40.0; and
   d) a density within the range from 0.910 to 0.930 g/cm³.
P.13 The stretch cling film of any one of the previous numbered paragraphs, wherein the cling layer polyolefin has an I₂ within the range of 5.0 to 25.0.
P.14 The stretch cling film of any one of the previous numbered paragraphs, wherein Un-stretched Cling (Cling at 0% stretch) is less than 200 g, or 150 g, or 130 g.
P.15 The stretch cling film of any one of the previous numbered paragraphs, wherein the

Highlight Ultimate stretch is greater than 350%, 365%, or 380%.
P.16 The stretch cling film of any one of the previous numbered paragraphs, wherein the polyolefin additive is adjusted so that as the film is stretched, the Cling (grams) is approaching or equal to the value for the un-Stretched Cling.
P.17 The stretch cling film of any one of the previous numbered paragraphs, wherein the Cling Retention is within a range from 40% or 45% or 50% to 70% or 75% or 80% or 85% or 90% or 95%.

Also disclosed is the use of a stretch cling film as a packaging wrap, the stretch cling film having Cling Retention greater than 50%, or 60%, or 70% comprising a cling layer comprising an ethylene-based polymer, wherein the film Parallel Cling Force at 200% is greater than 50g, or 60g, or 70g. The film may be further defined as in any of the previous numbered paragraphs.

For all jurisdictions in which the doctrine of “incorporation by reference” applies, all of the test methods, patent publications, patents and reference articles are hereby incorporated by reference either in their entirety or for the relevant portion for which they are referenced.

What is claimed is:

1. A stretch cling film having Cling Retention greater than 50% comprising a cling layer comprising an ethylene-based polymer wherein the film Parallel Cling Force at 200% is greater than 50 g.

2. The film of claim 1, wherein the cling layer polyolefin has an 1₂ within the range of 5.0 to 25.0 g/10 min.

3. The film of claim 1, wherein Un-stretched Cling is less than 200 g.

4. The film of claim 1, wherein the Highlight Ultimate stretch is greater than 350%.

5. The film of claim 1, wherein total film gauge is less than 20, or 15, or 12 or 10 microns.

6. The A stretch cling film having Cling Retention greater than 50% comprising a cling layer comprising an ethylene-based polymer having an I₂ within the range from 5.0 to 25 g/10 min, and I₂₁/I₂ within the range from 9.0 to 40.0.

7. The film of claim 6, having a Parallel Cling Force at 0% stretch within the range from 50 g to 300 g, and a Parallel Cling Force at 200% stretch within the range from 30 g to 300 g.

8. The film of claim 6, wherein the cling layer comprises within the range from 50 wt % to 96 wt % of the ethylene-based polymer.

9. The film of claim 6, wherein the cling layer further comprises a polyolefin additive, wherein the polyolefin additive is a propylene-based elastomer, a polyalphaolefin (PAO), an ethylene-based plastomer, or a combination thereof.

10. The film of claim 9, wherein the polyolefin additive is the propylene-based elastomer having an ethylene content within the range from 5 to 25 wt % ethylene derived units and a Tₘ within the range from 25 to 110° C.

11. The film of claim 6, wherein the cling layer further comprises within the range from 5 wt % to 40 wt % of a linear low density polyethylene having an I₂ within the range from 0.1 g/10 min to 5.0 g/10 min.

12. The film of claim 6, wherein the MD 1% secant modulus is within a range of from 12 kpsi to 25 kpsi; and the TD 1% secant modulus is within a range of from 14 kpsi to 26 kpsi.

13. The film of claim 6, having an MD tensile yield strength within the range of from 800 psi to 1800 psi; and a TD tensile yield strength within the range from 700 psi to 1400 psi.

14. The film of claim 6, having a Cling Retention within a range from 40% to 95%.

15. The film of claim 6, wherein the film has a Parallel Cling Force of less than 200 grams at 0% stretch and greater than 50 grams at 200% stretch.

16. The film of claim 9, wherein the film comprises a cling layer comprising PAO and propylene-based elastomer in the film or cling layer with the ethylene-based polymer within the range from 60% to 95 wt %, the propylene-based elastomer within the range from 30% to 4.5 wt %, and PAO within the range from 10% to 0.5 wt %.

17. The film of claim 16, wherein the propylene-based elastomer comprises within the range from 12 to 22 wt % ethylene-derived units.

18. A multi-layered stretch cling film, comprising at least a cling layer, the film having a Parallel Cling Force of less than 200 grams at 0% stretch and greater than 50 grams at 200% stretch, the cling layer comprising an ethylene-based polymer having:
a) a melt index, I₂, within the range from 5.0 to 25.0 g/10 min;
b) a high-load melt index, I₂₁, within the range from 80.0 to 160.0 g/10 min;
c) a melt index ratio (I₂₁/I₂) within the range from 9.0 to 40.0; and
d) a density within the range from 0.910 to 0.930 g/cm³.

19. The film of claim 18, wherein the cling layer further comprises within the range from 4 wt % to 25 wt % of a polyolefin additive, wherein the polyolefin additive is a propylene-based elastomer, a polyalphaolefin, ethylene-based plastomer or a combination thereof.

20. The film of claim 18, wherein the cling layer further comprises within the range from 5 wt % to 40 wt % of a linear low density polyethylene having an I₂ within the range from 0.1 g/10 min to 5.0 g/10 min and a density of less than 0.925 g/cm³.

21. The film of claim 18, having a MD 1% secant modulus within a range of from 12 kpsi to 25 kpsi; and a TD 1% secant modulus within a range of from 14 kpsi to 26 kpsi.

22. The film of claim 18, having a MD tensile yield strength within the range of from 800 psi to 1800 psi; and a TD tensile yield strength within the range from 700 psi to 1400 psi.

23. The film of claim 18, having a MD Elmendorf Tear within the range from 100 g/mil to 500 g/mil; and a TD Elmendorf Tear within the range from 350 g/mil to 800 g/mil.

24. The film of claim 19, wherein the polyolefin additive is adjusted so that as the film is stretched, the Cling (grams) is approaching or equal to the value for the un-Stretched Cling.

25. The film of claim 18, wherein total film gauge is less than 20, or 15, or 12 or 10 microns.
